(19) United States
(12) Patent Application Publication
(10) Pub. No.: US 2026/0032134 A1
(43) Pub. Date: Jan. 29, 2026

(54) METHOD FOR GENERATING TRAINING DATA FOR USE IN TRAINING A MACHINE LEARNING MODEL USED TO DETECT MALWARE

(71) Applicant: Robert Bosch GmbH, Stuttgart (DE)

(72) Inventors: Christopher Huth, Heilbronn (DE); Dominik Germek, Berlin (DE); Martin Ring, Lossburg (DE); Max Camillo Eisele, Ludwigsburg (DE); Niclas Ilg, Ammerbuch (DE)

(21) Appl. No.: 19/264,131

(22) Filed: Jul. 9, 2025

(30) Foreign Application Priority Data
Jul. 24, 2024 (DE) 10 2024 206 958.2

(51) Int. Cl. H04L 9/40; H04L 41/16

(52) U.S. Cl. CPC H04L 63/1416; H04L 41/16

(57) ABSTRACT

A method for generating training data for use in training a machine learning model used to detect malware, in particular in operating software for a technical system. The method includes: providing malware data, which include a plurality of decompositions, wherein each decomposition comprises function blocks that are or have been obtained by decomposing an attack vector; providing good software data, which comprise a plurality of decompositions, wherein each decomposition comprises function blocks that are or have been obtained by decomposing a good software sample; generating the training data, on the basis of the malware data and the good software data, wherein the training data comprise adapted good software samples, which are each based on function blocks of a corresponding good software sample that are supplemented with one or more function blocks of the malware data; and providing the training data for use in training the machine learning model.

### FIELD

The present invention relates to a method for generating training data for use in training a machine learning model used to detect malware, for this purpose, and to a computing unit and a computer program for carrying out said method.

### BACKGROUND INFORMATION

So-called open-source software can be used in many different areas. Due to the almost unmanageable number of different open-source software and due to the lack of verification thereof in some cases, the presence of malware in open-source software often cannot be ruled out.

### SUMMARY

The present invention provides a method, in particular a computer-implemented method, for generating training data and a computing unit and a computer program for carrying out said method. Advantageous example embodiments of the present invention are disclosed herein.

The present invention deals with the detection of (potential) malware contained in other software. Such software could include, for example, so-called open-source software but also internal software or other third-party software. In particular, this involves detecting malware in operating software for a technical system, e.g., a control device.

Open-source software or open-source software packages have become an essential cornerstone of modern software development. It is estimated that free and open-source software accounts for 70 to 90% of any modern software solution. The availability of such software packages therefore shapes almost every aspect of modern software-based solutions, products, and services.

Numerous packages can be downloaded from one of many software package registries, including npm (JavaScript), PyPI (Python), RubyGems (Ruby), and others. In a distributed manner across these registries, developers publish tens of thousands of updates and upload hundreds of new packages every day, creating a collection of several million openly available software packages.

Unfortunately, this overwhelming availability of free software comes at a price, namely, potentially dangerous software, also generally referred to as malware below. In particular, this means that a software package has been modified in order to actively carry out an attack. This is in contrast to conventional vulnerabilities in software, which are not actively provided.

The increased risk can result from different factors: (1) anyone can upload such software packages, (2) only a limited number of packages is digitally signed or verified, and (3) the repositories or databases generally do not have an active detection mechanism in order to detect and, where appropriate, sort out such malware. In this environment, it is easily possible to introduce manipulated software packages (i.e., malware) in order to carry out attacks on the supply chain, i.e., where the software is then used. As has been shown, this problem goes far beyond the Javascript and Python ecosystem.

Although open-source software is a particular motivation here, the method explained below can also be applied to other types of software, i.e., software from any source.

As has been discovered, one solution to this problem is the use of machine learning (ML) methods, i.e., the use of machine learning models or artificial intelligence (AI), to automatically detect indicators of maliciousness or harmfulness in software benchmarks, i.e., to detect malware in general. However, ML-based detection requires a large set of software samples (so-called benchmarks) to train the machine learning model. As has been found, access to real malware or malicious software packages is extremely difficult since (1) malicious software is usually completely removed from the repositories after its discovery, and (2) due to the sensitive content of the packages, the repositories are typically unwilling to share the data, i.e., the (possibly already removed) malware, i.e., to make them available to others. Consequently, the lack of training data makes it very difficult to make ML-based detection techniques possible.

Against this background, a possibility is proposed to generate malware artificially or synthetically, in particular in an automated manner. This proposal is based in particular on a text-based decomposition and compilation of function blocks and, inter alia, large language models (LLMs) as machine learning models. In this way, meaningful and realistic malware (or malware benchmarks) can be generated and can be used to train ML-based detection models.

Below, various terms used within the scope the present application are briefly explained.
Function block: A function block is the smallest meaningful functional part of a software package that is or can be represented in a broken-down or decomposed manner. A function block could, for example, be a function or a number of functions that implement a specific behavior. In particular, it is proposed to represent function blocks in the form of textual (and thus human-readable) descriptions. An example of a function block could be a function that performs the following action: Connect to the remote server using a protocol such as FTP or SFTP.
Functional area: A functional area is a functional area (or region) of a group of function blocks that are related to one another and implement a specific, more complex behavior. For example, a functional area could be a group of function blocks that carry out an attack, e.g., pass confidential information to a remote server. The functional area that represents this attack could thus consist of the following function blocks:
1) Turn off logging.
2) Open the desired local file in read mode.
3) Read the content of the file.
4) Connect to the remote server using a protocol such as FTP or SFTP.
5) Open a file on the remote server in write mode.
6) Write the content read from the local file to the remote file.
7) Close the remote file.
8) Close the local file.
9) Continue logging.
Decomposition: A decomposition is the entire software (i.e., for example, a software package) that is represented in the form of connected function blocks.
Software sample (SW sample): A software sample (or software pattern or SW sample) is a software package, including its code, its configuration files, and other components. For example, a software package could be a Python library for distributed ML model training. It should be noted that the term “software package” does not have to be limited to software components from online registers. In principle, any small piece of code or software written in any programming language can be used as a software sample. Furthermore, there is also no restriction to a specific programming language. A software sample relates to a decomposition.
Software type: A software type is the type of functionality that a particular software sample (of any granularity) implements. Examples of software types include mathematical libraries, cryptography libraries, machine learning libraries, graphics libraries, and others. The type therefore refers in particular only to the general description of the functionality but not to the details of the implementation, such as programming language, code structure, algorithm specifics, file extensions, and others.

According to an example embodiment of the present invention, first, malware data and good software data are provided. These data may have been obtained independently of one another; the order is not relevant.

The malware data comprise a plurality of decompositions, wherein each decomposition comprises function blocks that have been obtained by decomposing an attack vector. An attack vector is, in particular, a possible attack path or a (possibly distributed/multi-stage) process by which an unauthorized intruder, regardless of type, can penetrate or compromise a foreign computer system in order to either take it over or at least misuse it for their own purposes. Attacks sometimes go beyond their own purposes, such as leaking files to the Internet or causing a system to stop responding (DOS). Ultimately, connected function blocks for an attack vector are thus available, in a comparable manner to a software sample. For this purpose, for example, a set of known attack vectors is collected from various sources and decomposed into function blocks, resulting in the plurality of decompositions (or a set of attack decompositions).

The good software data comprise a plurality of decompositions, wherein each decomposition comprises function blocks that have been obtained by decomposing a good software sample. A good software sample is a software sample that is known or at least can be assumed not to be or contain malware. The good software samples may comprise good software samples which are collected for each of various software types and in particular come from various sources. The good software samples may also comprise, for example, for at least one of the different software types, one or more good software samples generated from at least one of the collected good software samples.

Good software samples can thus be collected for a number of different software types and decomposed into functional blocks, leading to the plurality of decompositions. Optionally, additional variants of good software samples are generated, e.g., by reconfiguration (further details are explained below), before the decomposition.

According to an example embodiment of the present invention, the training data are then generated on the basis of the malware data and the good software data. This is carried out such that the training data comprise adapted good software samples, which are each based on function blocks of a corresponding good software sample that are supplemented with one or more function blocks of the malware data. For this purpose, the malware data and the good software data can be compared, for example, in order to determine or find matching areas of corresponding function blocks. In particular, the decompositions of the malware data and the good software data are compared with one another. The function blocks of the good software data are then supplemented, in the matching areas, with the corresponding function blocks of the malware data. Based thereon, the adapted good software samples are then generated. The adapted good software samples are thus artificially or synthetically generated malware.

In this context, it should be mentioned that malware is typically always artificially generated in some way. In the context of the present application, however, this should be understood in particular to mean that this malware is generated specifically for the training of a machine learning model with which malware can then be detected, and not for actual attacks.

When training the machine learning model used to detect malware, the training data are generated as described above and provided for training. The machine learning model is then trained on the basis of the training data in such a way that, on the basis of the training data as input data for the machine learning model, output data are determined that comprise information about the presence of malware in the input data. The trained machine learning model is then provided, e.g., for use as described above. As mentioned, the training data comprise the adapted good software samples, i.e., artificially or synthetically generated malware. In this respect, the training data thus also include the information that this is such malware. The data may be labeled or annotated on multiple levels. For example, the entire software may be labeled as malware or good software, or else only harmful functional areas, and thus also the function blocks of malware

The procedure according to the present invention can thus be used to generate synthetic malware or malware benchmarks that are adapted to real attack descriptions. The entire process is independent of the language and structure of the software and can therefore be applied to both scripting languages and embedded code. The procedure according to the present invention is applicable to any software size, from large projects to small code snippets.

In one example embodiment of the present invention, the machine learning model trained in this way is used to detect malware in a software sample. Such a software sample is in particular operating software for a technical system, e.g., a control device. In general, however, a vehicle, a component or a control device of a vehicle, or a robot or a control device of a robot are also possible as a technical system. In addition, a sensor, in particular an embedded sensor or another embedded system, can be considered.

A computer program for a technical system is understood to mean, in particular, a computer program that, when executed on a computing unit, causes the computing unit, i.e., for example, a control device, to carry out an operating or control method. When executed, the operating or control method may, for example, comprise receiving signal or measurement values and outputting control signals. If the control device is, for example, an engine control device, the control signals may cause fuel injectors or an electric motor to be controlled.

A software sample, i.e., in particular, the operating software, is used for the operation of the technical system, i.e., for example, loaded onto the control device, only if no malware has been detected by means of the proposed procedure. In this way, the operation of the technical system, i.e., for example, of the control device, of the components controlled by it, such as an engine or a vehicle, can be ensured since the presence of malware can at least be ruled out with a high degree of probability.

A computing unit according to the present invention, e.g., a computer or server (e.g., also in the so-called cloud), is configured, in particular in terms of programming, to carry out a method according to the present invention.

Furthermore, the implementation of a method according to the present invention in the form of a computer program or computer program product having program code for carrying out all method steps of the present invention is advantageous since it is particularly low-cost, in particular if an executing control device is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description herein and the figures.

The present invention is shown schematically in the figures on the basis of exemplary embodiments and is described below with reference to the figures.

### BRIEF DESCRIPTION OF THE DRAWINGS

FIG. 1A schematically shows an arrangement in which the present invention can be used.

FIG. 1B schematically shows a sequence of a method in one example embodiment of the present invention.

FIG. 2, 3, 4, 5 each show part of a method in one embodiment of the present invention.

### DETAILED DESCRIPTION OF EXAMPLE EMBODIMENTS

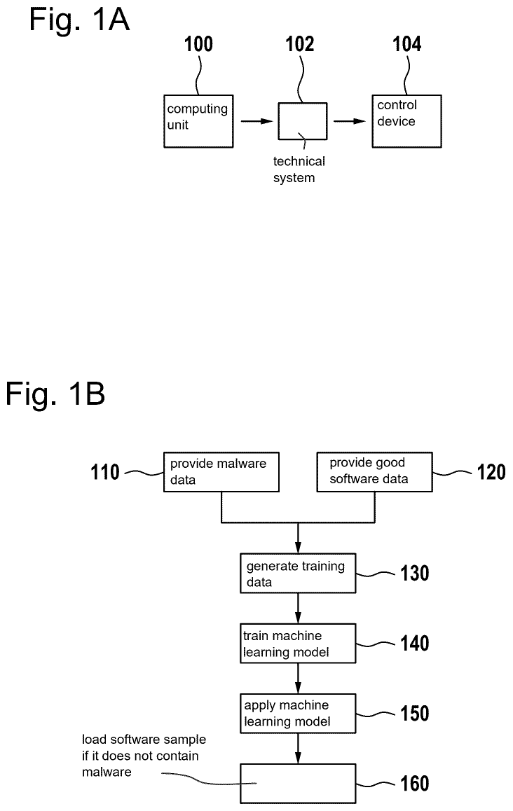

FIG. 1A schematically shows an arrangement in which the present invention can be used. The arrangement comprises, for example, a computing unit 100, e.g., a computer or a server, and a technical system 102, which may, for example, be a control device of a vehicle.

Furthermore, a software or software sample 102 is shown. This is in particular a computer program that, when executed on a computing unit, causes the computing unit, in this case the control device 102, to carry out an operating or control method. When executed, the operating or control method may, for example, comprise receiving signal or measurement values and outputting control signals. If the control device is, for example, an engine control device, the control signals may cause fuel injectors or an electric motor to be controlled.

If, for example, a new version of the software 102 is to be loaded onto or applied to the control device 104, the software 102 should be free of malware in order to ensure safe and reliable operation of the control device or the component controlled by it.

For this purpose, the software or software sample 102 can first be checked for malware. A sequence of a method for this purpose is shown, in one embodiment, in FIG. 1B.

In a step 110, malware data are provided, which comprise a plurality of decompositions, wherein each decomposition comprises function blocks that are or have been obtained by decomposing an attack vector.

In a step 120, good software data are provided, which comprise a plurality of decompositions, wherein each decomposition comprises function blocks that are or have been obtained by decomposing a good software sample.

In a step 130, training data are then generated on the basis of the malware data and the good software data; these training data are then provided for use. The training data comprise adapted good software samples, which are each based on function blocks of a corresponding good software sample that are supplemented with one or more function blocks of the malware data.

In a step 140, a machine learning model is then trained on the basis of the training data; this is carried out in such a way that, on the basis of the training data as input data for the machine learning model, output data are determined that comprise information about the presence of malware in the input data. The machine learning model trained in this way is then provided for use or application.

In a step 150, the trained machine learning model is then applied, for example, to the software sample 102. Output data are then determined, which comprise information about the presence of malware in the input data, i.e., in this case, the software sample 102.

In a step 160, if the software sample 102 does not comprise or contain any malware, it is loaded onto the control device 104, for example, and can be used there for safe operation. The steps 110 to 150 can be performed on the computing unit 100 or on various computing units. The computing unit 100 (or another computing unit) can also be used to load the software sample onto the control device.

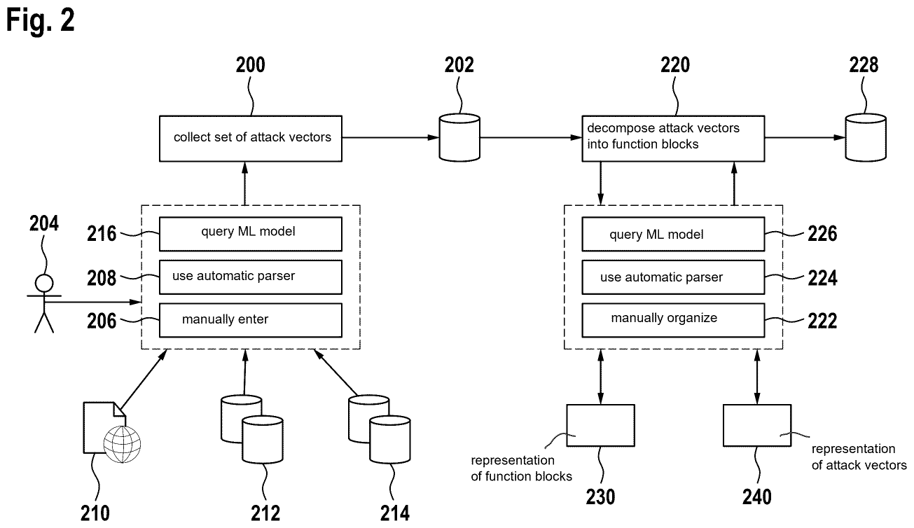

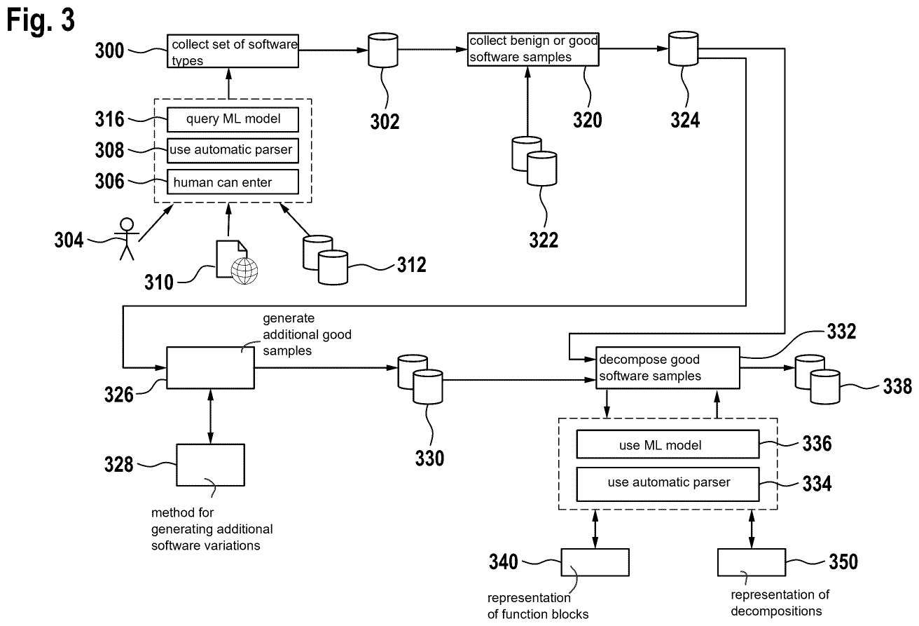

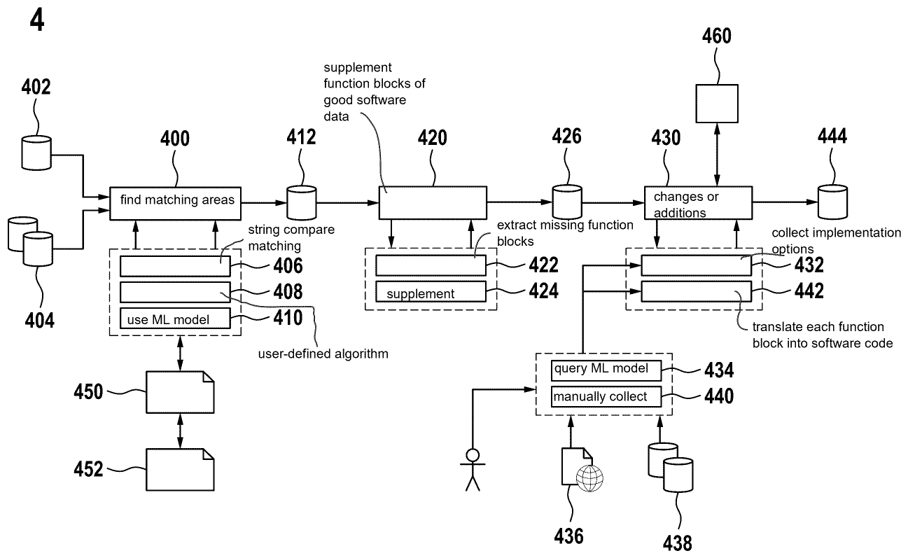

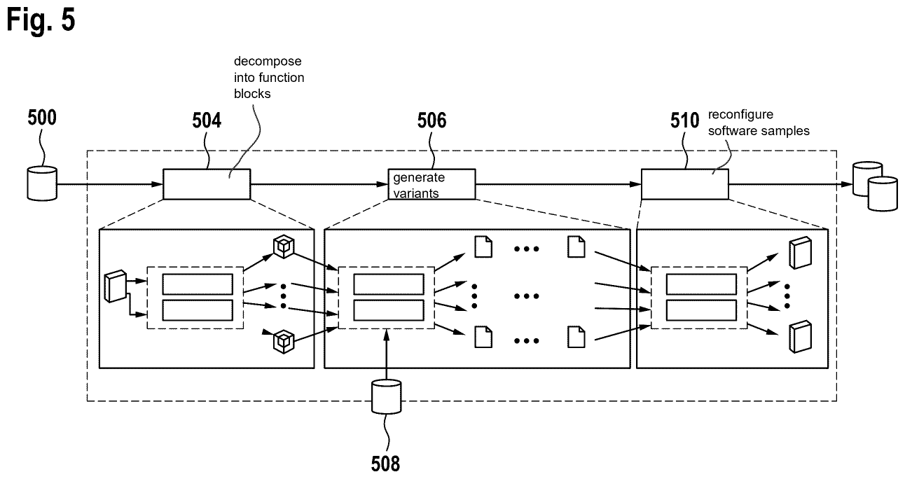

The steps 110, 120, 130 are explained in more detail below with reference to FIG. 2, 3, 4 on the basis of one embodiment.

With reference to FIG. 2, step 110 is explained in more detail on the basis of one embodiment. One goal of this step is, in particular, to create a database of attack vector decompositions, i.e., decompositions with function blocks that are obtained by decomposing an attack vector.

For this purpose, in step 200, a set of attack vectors can be collected, which is then stored in a database 202; multiple databases can also be used for this purpose, e.g., depending on where the attack vectors come from. An attack vector is, for example, a textual description of steps required to carry out a specific attack. Attack vectors can be obtained from various sources.

For this purpose, e.g., a (human) user 204 can manually enter attack vectors, step 206. For example, an automatic parser can also analyze and extract attack paths from various sources, step 208. Such sources can, for example, be forums and websites from the Internet (and Deep Web), 210, databases with known malicious software, 212, and/or vulnerable software, 214, i.e., malware in general. Attack vectors can also be extracted from literature, e.g., scientific papers, blogs, and others.

A machine learning model (ML model) can also be used, step 216: Known attack vectors can be collected by querying an ML model (e.g., an LLM). In a general case, an LLM already contains knowledge from the previous sources of attack vectors.

Then, in step 220, the attack vectors can be decomposed into function blocks, with each attack vector (textual description) being decomposed into attack steps. Each step represents a single functional block.

Decomposing into function blocks can be carried out in various ways, e.g., by manual description by a (human) user who manually (with a one-time effort) organizes attack descriptions into steps, step 222.

An automatic parser can analyze and extract attack steps (function blocks) from an attack description, e.g., through a regex-based analysis, step 224. Another example is the extraction of comments in malicious software code. The comments (provided they are of good quality) can be used to extract the descriptive function blocks.

A machine learning model (ML model) can also be used, step 226: Attack steps can be ascertained by querying an ML model (e.g., an LLM). In a generic case, an LLM already contains knowledge from the previous sources.

The thus obtained decompositions of attack vectors can then be stored in a database 228; multiple databases can also be used for this purpose.

It should be noted that, in this step 110, or the sequence according to FIG. 2, certain parts can have a modular structure, namely, the representation of function blocks, 230, and the representation of decompositions, here of attack vectors, 240. This is explained in more detail below.

With reference to FIG. 3, step 120 is explained in more detail on the basis of one embodiment. In particular, one goal of this step is to create a database of benign decompositions, i.e., decompositions with function blocks that are obtained by decomposing good software samples.

For this purpose, in step 300, a set of software types can be collected from various sources and stored in a database 302. A software type is, for example, a general description of the functionality that a software package implements. Software types can be obtained from multiple sources.

For this purpose, e.g., a (human) user 304 can enter software types on the basis of previous experience, step 306. Furthermore, an automatic parser, for example, can analyze and extract software types from various sources, step 308. Such sources can, for example, be forums and websites from the Internet (and Deep Web), 310, metadata, comments or descriptions from software repositories, 312, or existing software classifications.

A machine learning model (ML model) can also be used, step 316: Known software types can be collected by querying an ML model (e.g., an LLM). In a generic case, an LLM already contains knowledge from the previous sources for software types.

Then, in step 320, benign SW samples or good software samples can be collected. For each software type, a set of good software samples is collected. Good software samples can come from various sources, including SW repositories, 322, open-source Git repositories, and local project files.

It should be noted that, in principle, actually (i.e., verified) benign software samples are not required, because it is possible, at least with a high degree of probability or with a sufficiently high degree of probability, to rely on the fact that the software samples are benign, if they have been tested, reviewed, used, and verified by many parties or users over a long period of time.

The good software samples can then be stored, for example, in a database 324.

Optionally, in step 326, additional good software samples, i.e., benign software variants, can be generated on the basis of already available good software samples, i.e., the good software samples collected as described above. There is no specific method for generating additional software variants. A possible method 328 for generating additional software variations through reconfiguration is explained in more detail below.

If desired, the variations created can also be verified, e.g., through tests, in order to ensure that they are still harmless. These additional good software samples can then be stored, for example, in a database 330 (or the database 324).

Then, in step 332, the good software samples can be decomposed into function blocks. It should be noted that there is a difference between the decomposition of good software samples and that of attack vectors. Creating attack decompositions means translating textual descriptions of attacks into decompositions of function blocks. In contrast, good software samples are software packages that must be decomposed into function blocks. The format of the decomposition does not necessarily have to be the same, but as explained in more detail below, comparison and alignment should always be possible if the representation of the decompositions follows the required features.

For the sake of simplicity, however, it can be assumed that both the decompositions of attack vectors and those of good software samples are presented in the same format. Decompositions therefore represent an intermediate representation that combines attack vector descriptions and software.

Like the attack vectors, the good software samples or software samples in general can also be translated into decompositions in various ways.

Decomposing into function blocks can be carried out in various ways, e.g., by manual description by a (human) user who manually (with a one-time effort) assigns software code to functional blocks connects them with a decomposition.

An automatic parser can analyze and extract function blocks from a software code, e.g., by extracting each function or each basic block, analyzing comments in the code, and the like, step 334.

A machine learning model (ML model) can also be used, step 336: A software can also be analyzed and decomposed by an ML model (LLM). A user can enter the entire SW code into an LLM and ask for a description of each function (or another granularity).

The process of decomposing attack vectors (step 110) and that of decomposing good software samples (120) can be very similar, e.g., by querying an LLM with a different input prompt.

The thus obtained decompositions of good software samples can then be stored in a database 338.

It should be noted that, in this step 120, or the sequence according to FIG. 3, certain parts can have a modular structure, namely, the generation of SW variants, 328, the representation of function blocks, 340, and the representation of decompositions, here of good software samples, 350. This is explained in more detail below.

With reference to FIG. 4, step 130 is explained in more detail on the basis of one embodiment. One goal of this step is, in particular, to combine the decompositions of the attack vectors and the decompositions of the good software samples in order to generate adapted good software samples, i.e., good software samples containing malware (malicious SW benchmarks).

For this purpose, in step 400, matching areas can be found or identified: The decompositions of the good software, 404, are compared with the decompositions of the attack vectors, 402, in order to identify areas with common or corresponding function blocks.

It should be noted that it is in principle possible that no or no direct match is found. In these cases, however, the comparison can ascertain the best location for inserting the additional function blocks.

Matching areas can be identified in various ways; for example, string compare matching, step 406, can be carried out: Since the decompositions contain function blocks that have certain features, a search algorithm can be used to identify matching areas.

A user-defined adaptation algorithm or matching algorithm can also be used, step 408, to identify matching areas. The algorithm can be based on the similarity of the function blocks, the order of the function blocks, or other features. In a user-defined implementation, a similarity assessment can be used to determine whether two groups of function blocks represent similar areas. There are no limits to the similarity calculation. A machine learning model (ML model) can also be used, step 410: An ML model can be used to identify matching regions.

The matching areas thus obtained can then be stored in a database 412.

Then, in step 420, function blocks of the good software data can be supplemented, in the matching areas, with the corresponding function blocks of the malware data in order to fulfill the functionality of the attack described in the decompositions.

For this purpose, in step 422, missing function blocks can be extracted from the decompositions of the attack vectors. In step 424, the function blocks of the good software data can then be supplemented in the matching areas. This may, for example, comprise appending and/or prepending and/or inserting function blocks in the matching areas.

The supplemented function blocks or decompositions thus obtained can then be stored in a database 426.

Then, in step 430, the changes or additions made in this way can be reflected in the good software samples: In the previous steps, a number of decompositions with malicious areas were created. They should now be translated into specific software samples (benchmarks).

For this purpose, in step 432, a number of implementation options for each function block in the malicious areas can be collected. This can be carried out by querying an ML model, 434, retrieving example implementations from the Internet, 436, or databases, 438, or manually collecting a number of implementation options, 440.

In step 442, each function block can then be translated back into software code. This step can, for example, be carried out either by a deterministic mapping process or by a machine learning model.

After all changes in the software have been taken into account, the end result of the present invention is a set of malware benchmarks that can be stored in a database 444.

It should be noted that, in this step 130, or the sequence according to FIG. 4, certain parts can have a modular structure, namely, a matching algorithm 450 for ascertaining matching areas (cf. also step 408), a similarity assessment 452 used in the process, and an algorithm 460 in step 430.

The modular parts mentioned are explained in more detail below. As mentioned, certain parts can have a modular structure, i.e., there is no restriction on how these parts can or should be implemented.

Representation of function blocks, cf. 230 in FIGS. 2 and 340 in FIG. 3.

As mentioned above, a function block is the smallest meaningful functional part of a software package that is represented in a broken-down or decomposed manner. The present application is not limited to a specific representation or granularity of a function block. However, the representation of function blocks should have certain features, such as:
Descriptiveness: The representation of the function block should contain a description of the functionality that the block implements.
Parsability: The representation of the function block should be able to be analyzed by a machine.
Distinctiveness: The representation should make it possible to distinguish between different function blocks.

Existing formats can also be used for the representation if they meet the above requirements. For example, a function block can be represented as a single processor instruction, as a single function call, as a basic block in a control and data flow diagram, as a sequence of instructions, as a sequence of API calls, and the like.

Representation of decompositions, cf. 240 in FIGS. 2 and 350 in FIG. 3. The representation of a decomposition is not limited to a specific format. However, the representation of a decomposition should have certain features, such as:
Adaptability: The representation of the decomposition should be adaptable, i.e., function blocks can be added, removed, or changed.
Reconstructibility: The representation of the decomposition should be reconstructible, i.e., the representation should be able to be reproduced in the software. More specifically, if necessary, only the adapted parts of the decompositions must be able to be reproduced in the software.
Parsability: The representation of the decomposition should be able to be analyzed by a machine.

Examples of possible representations of decompositions are a control and data flow diagram and an abstract syntax tree.

Generation of additional benign software variants, i.e., further good software samples, cf. 328 in FIG. 3.

The generation of additional benign software variants is an optional step. The goal of this step is to generate additional benign software variations on the basis of already available benign software samples, i.e., good software samples. In principle, this corresponds to the typical step of data augmentation. The challenge, however, is how data augmentation can be carried out in the context of software. The present application does not set any specific limits on how data augmentation should be carried out. However, the generation of additional good software samples should result in functionally equivalent (or at least very similar) software samples.

FIG. 5 presents a possible way to generate additional benign software samples through reconfiguration.

The input for this process is, for example, a data set 500 with software samples linked to software types. The output 502 is the same data set populated with further variants of software samples.

The process is described below taking into account only one software sample, but the same process can be repeated for all software samples in the data set 500.

In step 504, decomposing into function blocks is carried out: Using the decomposition concept explained and presented above (procedure for generating a decomposition), a software sample is decomposed into function blocks.

In step 506, variants are generated: For each function block, a list of potential code variants that represent this function block is created. The variants are generated, for example, by using ML (e.g., LLMs), by retrieving variants from an existing database 508, or by other code transformations.

In step 510, software samples are reconfigured: Using ML or a user-defined replacement method, the original software sample is reconfigured with the available function block variants (the existing blocks are replaced by a new variant). This can be repeated for all function blocks in the software sample, creating a plurality of new software samples. The changes to the function blocks are reflected in the code in the same way as explained above.

Reflection of changes, cf. 460 in FIG. 4.

After the addition, the added, removed, or, in general, adapted function blocks in the decompositions must be returned to the actual software implementation. In the context of this application, it is however irrelevant how this is carried out. However, preferably, this is, for example, carried out by manually writing, deterministically generating software from the previous artifacts, or generation by an ML model (such as an LLM).

1-13 (canceled)

14. A method for generating training data for use in training a machine learning model used to detect malware, in operating software for a technical system, comprising the following steps:
providing malware data, which include a plurality of decompositions, wherein each decomposition includes function blocks that are or have been obtained by decomposing an attack vector;
providing good software data, which include a plurality of decompositions, wherein each decomposition includes function blocks that are or have been obtained by decomposing a good software sample;
generating the training data based on the malware data and the good software data, wherein the training data include adapted good software samples, which are each based on function blocks of a corresponding good software sample that are supplemented with one or more function blocks of the malware data; and
providing the training data for use in training the machine learning model.

15. The method according to claim 14, wherein the technical system is a control device.

16. The method according to claim 14, wherein the obtaining of the plurality of decompositions of the good software data by decomposing good software samples includes:
providing the good software samples, wherein the good software samples include good software samples which are collected for each of various software types and come from various sources; and
decomposing the good software samples into function blocks.

17. The method according to claim 16, wherein the good software samples for at least one of the various software types include one or more good software samples generated from at least one of the collected good software samples.

18. The method according to claim 17, wherein the good software sample generated from the at least one of the collected good software samples is generated by reconfiguration from the at least one of the collected good software samples.

19. The method according to claim 14, wherein the generating of the training data includes:
comparing the malware data and the good software data to determine matching areas with corresponding function blocks;
supplementing the function blocks of the good software data, in the matching areas, with the corresponding function blocks of the malware data; and
generating the adapted good software samples based on the function blocks of the good software data supplemented with a function block of the malware data.

20. A method for training a machine learning model used to detect malware, in operating software for a technical system, comprising the following steps:
generating and providing training data by:
providing malware data, which include a plurality of decompositions, wherein each decomposition includes function blocks that are or have been obtained by decomposing an attack vector,
providing good software data, which include a plurality of decompositions, wherein each decomposition includes function blocks that are or have been obtained by decomposing a good software sample,
generating the training data based on the malware data and the good software data, wherein the training data include adapted good software samples, which are each based on function blocks of a corresponding good software sample that are supplemented with one or more function blocks of the malware data, and
providing the training data for use in training the machine learning model;
training the machine learning model based on the training data in such a way that, based on the training data as input data for the machine learning model, output data are determined that include information about the presence of malware in the input data; and
providing the trained machine learning model.

21. A method for detecting malware, using a machine learning model trained by:
generating and providing training data by:
providing malware data, which include a plurality of decompositions, wherein each decomposition includes function blocks that are or have been obtained by decomposing an attack vector,
providing good software data, which include a plurality of decompositions, wherein each decomposition includes function blocks that are or have been obtained by decomposing a good software sample,
generating the training data based on the malware data and the good software data, wherein the training data include adapted good software samples, which are each based on function blocks of a corresponding good software sample that are supplemented with one or more function blocks of the malware data, and
providing the training data for use in training the machine learning model;
training the machine learning model based on the training data in such a way that, based on the training data as input data for the machine learning model, output data are determined that include information about the presence of malware in the input data; and
providing the trained machine learning model;
the method for detecting malware comprising the following steps:
providing input data for the machine learning model, wherein the input data include a software sample;
applying the machine learning model, wherein, based on the input data, output data are determined that include information about a presence of malware in the input data; and
providing the output data.

22. The method according to claim 21, wherein the method is for detecting malware in operating software for a technical system.

23. The method according to claim 22, wherein:
the software sample of the input data is the operating software for the technical system, and
wherein the software sample is used for operation of the technical system only when, according to the output data, no malware is present in the input data.

24. The method according to claim 22, wherein the technical system is one of the following technical systems:
a vehicle,
a component or a control device of a vehicle,
a robot or a control device of a robot,
a sensor.

25. A computing unit configured to generate training data for use in training a machine learning model used to detect malware, in operating software for a technical system, comprising the following steps:
providing malware data, which include a plurality of decompositions, wherein each decomposition includes function blocks that are or have been obtained by decomposing an attack vector;
providing good software data, which include a plurality of decompositions, wherein each decomposition includes function blocks that are or have been obtained by decomposing a good software sample;
generating the training data based on the malware data and the good software data, wherein the training data include adapted good software samples, which are each based on function blocks of a corresponding good software sample that are supplemented with one or more function blocks of the malware data; and
providing the training data for use in training the machine learning model.

26. A non-transitory machine-readable storage medium on which is stored a computer program for generating training data for use in training a machine learning model used to detect malware, in operating software for a technical system, the computer program, when executed by a computing unit, causing the computing unit to perform the following steps:
providing malware data, which include a plurality of decompositions, wherein each decomposition includes function blocks that are or have been obtained by decomposing an attack vector;
providing good software data, which include a plurality of decompositions, wherein each decomposition includes function blocks that are or have been obtained by decomposing a good software sample;
generating the training data based on the malware data and the good software data, wherein the training data include adapted good software samples, which are each based on function blocks of a corresponding good software sample that are supplemented with one or more function blocks of the malware data; and
providing the training data for use in training the machine learning model.
